(19) United States
(12) Patent Application Publication
(10) Pub. No.: US 2013/0151430 A1
(43) Pub. Date: Jun. 13, 2013

(54) SYSTEM AND METHOD FOR MODIFYING AND RE-DESIGNING EMPLOYEE BENEFIT PLANS

(71) Applicants: Heather Peters, Oakland, CA (US); Mary Greenawald, Oakland, CA (US); Mary E. Harris, Warrenton, NC (US); Jacqueline Kane, Oakland, CA (US)

(72) Inventors: Heather Peters, Oakland, CA (US); Mary Greenawald, Oakland, CA (US); Mary E. Harris, Warrenton, NC (US); Jacqueline Kane, Oakland, CA (US)

(21) Appl. No.: 13/479,177

(22) Filed: May 23, 2012

Related U.S. Application Data
(60) Provisional application No. 61/569,063, filed on Dec. 9, 2011.

(51) Int. Cl. G06Q 10/10

(52) U.S. Cl. CPC G06Q 10/1057
USPC 705/322

(57) ABSTRACT

The present invention is a computer-implemented system and method for creating employee benefits packages comprising: (a) defining total rewards package comprising: health care, pension, retirement plan, vacation and sick leave, annual employee bonuses, long-term incentives and employee pay; (b) conducting an employee survey, compiling and storing the results; (c) analyzing the results; (d) creating one or more sample redistributed total rewards packages; (e) applying the sample redistributed total rewards packages on multiple employee profiles; (f) measuring the costs and benefits for two or more employee profiles; and (g) selecting a final total rewards package from the sample redistributed total rewards packages.

### BACKGROUND OF THE INVENTION

### Field of the Invention

The present invention relates generally to a computer-implemented method for modifying employee benefit plans and redistributing funds among various employee benefits based upon prioritization and valuation information from employees, while subject to a cost constraint. The computer-implemented method of the present invention employs steps in the process which uses one or more computer systems and/or programs, but it should be clear that some of the steps in the process may require human analysis and input into the process to be completed. The method of the present invention defines employee benefit plans broadly as an employee total rewards package which includes: employee pay, annual incentive pay (e.g. bonuses), long-term incentive pay (e.g. equity), health care and welfare benefits, retirement programs, pension plans, and vacation and sick leave. Defining employee benefits more broadly allows the plans to be optimized to meet the need of a diverse group of employees. The method of the present invention prioritizes employee benefit plans design options based on the costs of the options and the perceived benefits of these options to the participating employees. The method utilizes a computer-implemented method for capturing employee input via, for example, but not limited to: a conjoint employee survey. The results of the employee input are then validated and clarified using the additional sources of employee input: for example, but not limited to: input via focus groups, analysis of sample employee profiles, etc. The employee input is then used modify the benefit plans based on the employees' prioritization of benefits and perceived value of the employee benefits to create a final total rewards package.

### Background of the Invention

Benefit plans that provide monetary value or compensation to participants and/or partial or complete reimbursement of expenditures incurred by participants in the plan are commonly offered by employers, associations, commercial entities and the like, that sponsor such plans as fringe benefits for employees or members or as a commercial service available to the general public. Potential sponsors of benefit plans are often constrained by resource limitations when making decisions about plan design options in the plans they offer to their participants. Lack of understanding of the relative perceived benefits attributed by the participants to the particular plan design options frustrates the efforts of sponsors to provide participants the most desirable plan design options within given cost constraints.

One of the biggest challenges that sponsors of benefit plans have faced in recent years is the rising costs of health care plans. As benefit plan sponsors, employers are forced to make difficult choices each year about how to modify the health care plans that they offer to their employees and how much of the costs for those plans will need to be passed on to their employees to work within their cost constraints. The net result for many employers and employees is that the cost of health care have risen dramatically and employees are having to contribute more and more each year for their premiums and are also facing higher costs when using the health plans, such as higher deductibles and higher out of pocket maximums. Many employees are dissatisfied with their rising health care costs and are interested in employee benefit plans that can help them adjust to this challenge.

Another significant challenge that has impacted employees is economic recession, rising unemployment and the significant decrease in value many employees have experienced in their property investments and retirement funds. In view of the tumultuous economic environment, employees are interested in having greater flexibility to influence, manage and use the funds they receive from their employers in the form of pay, annual employee incentives, pension, retirement, etc. Many employees are dissatisfied with employee benefit plans that allocate significant portions of their pay to plans that they cannot actively manage, influence and control.

In view of these challenges, a new method of modifying employee benefit plans is needed that will address the needs and priorities of the employees participating in the benefit plans while still adhering to the cost constraints of the benefit plan sponsor.

### SUMMARY OF THE INVENTION

The present invention provides a new and unique process for redesigning or modifying benefit plans based on employee input to maximize the perceived benefits derived from the plans by a diverse group of employees by having employees prioritize the options according to the relationship between perceived benefit and the cost of providing the option. Using the employee survey results and looking at the employee impact using sample employee profiles, the present invention also preferably offers benefit plan sponsors the ability to provide participants with redistributed total rewards plans having options most closely tailored to the participants' needs and desires. In addition, the process may also take into account the employers' cost constraints and market data of competitors for benchmarking purposes. The computer-implemented method of the present invention employs steps in the process which uses one or more computer systems and/or programs, but it should be clear that some of the steps in the process may require human analysis and input into the process to he completed.

The present invention is a computer-implemented method for modifying options and redistributing funds for employee benefits from the prior year employee benefit plan, wherein the modification and redistribution is based on the prioritization and perceived value of the benefit to a diverse group of employees, the method comprising: (a) defining the total rewards package to include employee benefits comprising: health care, pension, retirement plan, vacation and sick leave, annual employee bonuses; (b) conducting a conjoint employee survey, compiling the results and storing the results using a computer system; (c) analyzing the results to determine the relative value and prioritization of each of the employee benefits in relation to other employee benefits within the total rewards package; (d) creating one or more sample redistributed total rewards packages based on the results of the employee survey; (e) applying the sample redistributed total rewards packages on multiple employee profiles; (f) measuring the costs and benefits for two or more employee profiles using the sample redistributed total rewards packages; and (g) selecting a final total rewards package from the sample redistributed total rewards packages.

Through this process of developing sample redistributed total rewards packages based on employee survey results and then testing the sample redistributed total packages on two or more employee profiles allows for the sponsor to incorporate options and redesign benefit plans to offer the maximum perceived benefit to employees at a given cost to the sponsor. It should be understood that this process of developing sample redistributed total rewards packages may be a reiterative process such that steps in the process may need to be repeated before selecting a final total rewards package. For example, a sample redistributed total rewards packages may be developed based on the results from an employee survey, but after testing the sample total rewards package on two or more sample employee profiles the sample redistributed total rewards package may need to be redesigned to not adversely impact one or more sample employee profile. The resulting final total rewards package may be the result of many repetitions of one or more of the process steps (a)-(f) to achieve a total rewards package that maximizes the benefits and/or reduces the costs for a diverse group of employees in comparison with the prior year employee benefit plan.

### DETAILED DESCRIPTION OF THE INVENTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “survey” includes two or more such surveys.

Unless defined otherwise, all technical and scientific terms used herein have the same meaning as commonly understood by one of ordinary skill in the art to which the invention pertains. Although a number of methods and systems similar or equivalent to those described herein can be used in the practice of the present invention, the preferred materials and methods are described herein.

The terms “employee” or “participant” are used interchangeably and are meant to mean all the benefit plan recipients. The employees or participants in the benefit plan may include a diverse group of eligible individuals including, but not limited to: nonunion employees, production employees (e.g. plant and manufacturing employees), nonproduction employees, employees at a range of grade levels or salary tiers, employees at a wide variety of geographic locations. The group of eligible partisans or employees may be tailored to include one or more of these groups depending on the needs and objectives of the benefit plan sponsor.

The terms “benefit plan sponsor”, “sponsor” or “employer” are used interchangeably and are meant to mean the providers of a benefit plan for a group of eligible participants. It should be understood that although the term employer is frequently used to mean a benefit plan sponsor the present invention may apply to any sponsor of the benefit plan for a group of eligible participants.

The term “conjoint survey” is meant to mean a survey designed for conjoint analysis which is a statistical technique commonly used in market research to determine how people value and prioritize different features or options that make up an individual product or service or groups of groups of products and services. Conjoint analysis techniques may also be referred to as multi-attribute compositional modeling, discrete choice modeling, or stated preference research, and is part of a broader set of trade-off analysis tools used for systematic analysis of decisions. The purpose of conjoint analysis is to determine what combination of a limited number of attributes is most influential on respondent choice or decision making. For example, a controlled set of employee benefits and features of those benefits may be shown to employees and by analyzing how they make preferences between these employee benefits, the implicit valuation of the individual elements making up the complete employee benefits package (i.e. the total rewards package) can be determined. These implicit valuations (utilities or part-worths) can be used to create models that estimate costs and benefits of new employee benefits packages.

An “advisory team” means a select group of people who are familiar with the employer, the employee benefit plans and the options for modifying and re-designing the employee benefit plans in view of the employer's cost constrains. The advisory team may also have access to market data to understand how the benefits packages compare with other similar employers in a benchmarking analysis. The advisory team is preferably less than about fifty people and more preferably less than about twenty five people. The advisory team is capable of reviewing and analyzing the employee input and recommending changes to the total rewards packages. This may he a reiterative process where the advisory group recommends changes to the total rewards packages and then modifies or refines those recommendations based on employee input or further analysis of the impact of the recommended changes on sample employee profiles.

The terms “total rewards package” or “total rewards” mean a broad definition of employee benefits including: employee pay, annual incentive pay (e.g. bonuses), long-term incentive pay (e.g., equity), time off of work (e.g. sick leave, vacation, etc.), health care, wellness incentive plans, retirement plans, pension, financial planning services, and supplemental insurance plans (e.g. long-term health care insurance, disability, life insurance, etc.).

The term “redistributed total rewards package” may include a subset of the employee benefits which fall under the definition of total rewards or it may include a modified options for one or more of the benefit plans in the total rewards package. In one exemplary embodiment of the invention, a redistributed total rewards package may allocate more funds toward a retirement plan and allocate fewer funds to a pension plan or freeze the pension plan. In another example, the redistributed total rewards plan may contain fewer health care plan options than under the previous year total rewards package. The “previous year total rewards package” means the benefit plan package offered by the benefit plan sponsor in the prior year. The “final total rewards package” is the resulting output of the method of the present invention where the employee benefit plans are modified and funds are redistributed based on employee input while being subject to a cost constraint.

The term “wellness incentive plan” means a voluntary plan where eligible participants can complete activities that are beneficial to maintaining or improving their health and they are rewarded by a reduction in health care premiums or costs. The activities under the wellness incentive plan may include one or more of the following options: participants getting an annual physical exam, participants completing an on-line health risk assessment survey, participants obtaining lifestyle management coaching, participants getting an annual flu shot, participants getting an annual preventive screening from a health care professional, participants certifying that they do not use tobacco products, and participants certifying that they engage in regular fitness activities. The reduction in health care costs may take on a variety of forms including, but not limited to health care premium reductions, reimbursement for approved expenses, free, subsidized or reduced costs for fitness activities, gym memberships, and health care and wellness services.

The method and system of the present invention may preferably be utilized in applications wherein contingent benefits are provided to participants as part of a plan which is funded by a sponsor, such as health care, retirement, pension and other benefit plans. The invention may also preferably be used to design insurance plans covering life insurance, disability insurance, etc. The invention may preferably be used to optimize the design of benefit plans with cost limitations established by or for the benefit plan sponsor. Alternatively, by identifying and selecting plan design options that generate perceived benefits to the participants such that the participants are willing to pay additional amounts for certain benefits the system may be used to modify the cost constraint applied to total rewards benefit plans. Unlike other methods for optimizing employee benefits plans, the present invention defines employee benefits broadly under the total rewards package. The broad definition of total rewards creates a more holistic approach to rebalancing and prioritizing employee benefits. In addition, the method of the present invention relies on employee input to maximize the perceived benefits and priorities of the participants in the final total rewards package.

### Defining Total Rewards Packages

In an embodiment of the invention, the total rewards package is defined to include employee benefits comprising: health care benefit, pension, retirement plan, vacation and sick leave, employee pay, annual employee incentives and long-term incentives. In another embodiment of the invention, the total rewards package may include additional benefits such as: wellness incentive plans, financial planning services, supplemental insurance plans (e.g. long-term health care insurance, disability, life insurance, etc.).

In one embodiment of the invention, health care plans may include a variety of different options including, but not limited to: Health Maintenance Organizations (HMO), Preferred Provider Organizations (PPO), Consumer Driven Health (CDH), Health Reimbursement Account (HRA), prescription drug plans, dental plans, vision plans, wellness incentive plans, and the like. In one exemplary embodiment of the invention, one or more options offered by a sponsor may be eliminated to drive down health care plan costs by consolidating health care plan options. In another embodiment of the invention, one or more of the redistributed total rewards packages may include a reduction in health care premiums for certain participants and increased employer funding to the health care plans.

In another embodiment of the invention, the funding for health care premiums may be unevenly divided among participants in the plan depending on employee salary ranges. In this embodiment, the sponsor uses the employee's pay in conjunction with predetermined salary ranges to determine the amount he or she will pay for healthcare premiums. Under this system higher paid employees contribute a greater percentage of their pay or a higher dollar amount to health care premiums than employees who are at a lower salary range. In one embodiment of the invention, the salary ranges are adjusted because over time the distribution of employees in the various salary ranges or salary tiers shifts based on employee salary growth over time. To keep up with the shift in employee salary growth the salary tiers can be adjusted to reduce health care premium payments for a percentage of the employees.

In one embodiment of the invention, the retirement benefits may include but are not limited to a 401(k) plan, a Roth 401(k) plan, a pension plan, financial planning services and other similar retirement benefits. The retirement plan may include both employer and employee contributions to one or more of the retirement benefit plan options. For example, to encourage employees to save for their own retirement an employer may offer a matching contribution to a 401(k) plan up to a certain dollar amount or up to a given percentage of the employees' pay. In addition, employers can contribute a set amount of money or a percentage based on the employees' pay which is not contingent upon the employee participating or contributing their own money to a retirement plan.

One way to increase the flexibility that employees have with funds going into their retirement plan is to give them more options about how to save for their retirement and redistribute employer contributions into retirement funds, such as 401(k) plans, instead of pension plans which do not allow for employees to influence how their funds are being invested. In the event that the sponsor of the benefit plan offers a defined benefit pension plan there may be financials implications to freezing the pension plan that may allow additional funds to be redistributed to other employee benefits which employees' value.

Although employee pay and annual incentive pay and long-term incentives (e.g. bonuses, stock, stock options, etc.) are not typically grouped with other employee benefits as part of a total benefits package, under the total reward package annual incentive pay and long-term incentive pay are included as an employee benefit. In one embodiment of the invention, the number of employees that are eligible to participate in the annual incentive pay benefit is increased to include employees at a wider range of salary and grade levels. Eligible employees may include but are not limited to, production employees, plant employees, nonproduction employees, nonunion employees, and a wide variety of employees at different grade levels and various geographic locations.

Although not all time and attendance policies are traditionally characterized as employee benefits, they may be included as benefits under the total rewards package. Types of time and attendance benefits may include, but are not limited to the following: holidays, floating holidays, sick time, personal time, religious holidays, bereavement time, overtime, call-in pay, short-term disability, long-term disability or recurring disability benefits. In one embodiment of the invention, vacation, sick and/or personal time off work may be redistributed among production and nonproduction employees to create more consistency between among a diverse group of employees.

### Employee or Participant Input

The present invention allows for one or more types of input from employees or participants in the benefit plan. Suitable options for employee input include, but are not limited to: surveys, focus groups, conjoint surveys, and other any other similar types of input. One purpose of the employee input is to obtain data that can be analyzed to determine how employees perceive and prioritize the benefits they are being awarded by their benefit plan sponsor. Another purpose of the employee input, in particular the employee profiles, is to measure the impact of benefit plan changes on a variety of different types of participants under the total rewards package.

By using more than one type of employee input the total rewards package can be optimized for a wide variety of participants making up a diverse group of employees. In addition, the process of the present invention may he a reiterative process such that steps in the process may be repeated one or more times before a final total rewards package is selected, By way of example and not by way of limitation, any one or more of the following steps may be repeated one or more times: (b) conducting employee survey, compiling the results and storing the results using a computer system; (c) analyzing the results to determine the relative value and prioritization of each of the employee benefits in relation to other employee benefits within the total rewards package; (d) creating one or more sample redistributed total rewards packages based on the results of the employee survey; (e) testing the sample redistributed total rewards packages on multiple employee profiles; (f) measuring the costs and benefits for each employee profile using the sample redistributed total rewards packages. Having a reiterative process with employee input at various stages in the process creates a system where a broader range of diverse employees may benefit from the redistribution and modification of the total rewards package because the impact on each type of employee has been evaluated multiple ways in the process. In addition, the reiterative process and multiple points of employee input are designed to ensure that one group of employees are not disproportionately disadvantaged over another group of employees. This process is designed to increase consistency, fairness and maximize the perceived benefit to most participants in a given benefit plan.

### Method for Modifying and Re-designing Employee Benefit Plans

The present invention provides a new and unique process for redesigning or modifying benefit plans based on employee input to maximize the perceived benefits derived from the plans by a diverse group of employees by having employees prioritizing the options according to the relationship between perceived benefit and the cost of providing the option. In one embodiment, the present invention is a computer-implemented method for modifying options and redistributing funds for employee benefits from the prior year employee benefit plan, wherein the modification and redistribution is based on the prioritization and perceived value of the benefit to a diverse group of employees, the method comprising: (a) defining the total rewards package to include two or more of the employee benefits comprising: health care, pension, retirement plan, time and attendance benefits, annual employee incentives, long-term incentives, employee pay, wellness incentive plan, financial planning services; (b) generating employee input (e.g. employee surveys, conjoint surveys, focus groups, etc.), compiling the results and storing the results using a computer system; (c) analyzing the results to determine the relative value and prioritization of each of the employee benefits in relation to other employee benefits within the total rewards package; (d) creating one or more sample redistributed total rewards packages based on the results of the employee input; (e) testing the sample redistributed total rewards packages on multiple employee profiles or in advisory teams; (f) measuring the costs and benefits for two or more employee profiles using the sample redistributed total rewards packages; and (g) selecting a final total rewards package from the sample redistributed total rewards packages. It should be understood that the steps of method in the present invention may be performed out of order and one or more steps in the process maybe repeated.

### System for Modifying and Re-designing Employee Benefit Plans

The present invention may employ a computer-based system to store information about all the various employee benefits offered under the total rewards package. The computer system may be used for comparing the costs and benefits of employee benefits options and plans and storing employee input about the perceived value and prioritization of the various employee benefits and the sample redistributed total rewards plans. The computer-based system will employ an input device, a processor and an output device.

The input device is for receiving input about the employee benefits and employee input, in the form of employee surveys, focus group, sample employee profiles and the like. The processing device is connected to a memory device which stores the results of the employee input and may be programmed to produce data and results showing how employees prioritize and value various employee benefits in relation to one another. In one embodiment, the processing device may be used to perform conjoint analysis of employee input. Focus groups, advisory teams and other forms of human analysis of the employee input may be used to analyze and refine the employee input from the conjoint survey. The output device is connected to the processor and is capable of receiving results from employee input and the sample redesigned total reward plans and comparing the plans against the employee prioritizations and perceived benefits to generate a final total rewards package.

Although preferred embodiments of the invention and methods of practicing the same have been described herein, persons of ordinary skill in the art will recognize and appreciate that the invention encompasses and includes numerous modifications and variations thereto. Although the method is described as a computer-implemented method, it should be clear that one or more computer systems or programs may be used and one or more of the steps in the process may be performed without the use of a computer. The examples and embodiments described herein are intended to be by way of example and not by way of limitation to the scope and nature of the present invention. Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

We claim:

1. A computer-implemented method for modifying options and redistributing funds for employee benefits from the prior year total rewards package, wherein the modification and redistribution is based on the prioritization and perceived value of the benefit to a diverse group of employees, the method comprising:
a) defining the total rewards package to include employee benefits comprising: health care benefit, pension, retirement plan, vacation and sick leave, employee pay, annual employee incentives, long-term incentives;
b) conducting employee survey, compiling the results and storing the results using a computer system;
c) analyzing the results to determine the relative value and prioritization of each of the employee benefits in relation to other employee benefits within the total rewards package;
d) creating one or more sample redistributed total rewards packages based on the results of the employee survey;
e) applying the sample redistributed total rewards packages on multiple employee profiles;
f) measuring the costs and benefits for each employee profile using the sample redistributed total rewards packages; and
g) selecting a final total rewards package from the sample redistributed total rewards packages.

2. The method of claim 1, wherein the employee survey is a conjoint survey.

3. The method of claim 1 wherein the health care benefit contains fewer plan options than under the prior year total rewards package.

4. The method of claim 1, wherein costs of health care plan for greater than 50% of the diverse group of employees is lower than the costs under the prior year total rewards package.

5. The method of claim 1, wherein costs of health care plan for about 100% of the diverse group of employees is lower than the costs under the prior year total rewards package.

6. The method of claim 1, wherein the final total rewards package does not contain any monetary contribution to a pension plan.

7. The method of claim 1 wherein the retirement plan includes employee 401K plans and the final total rewards package redistributes more funds to employee 401K plans than under the prior year total rewards package.

8. The method of claim 1, wherein the employee profiles comprise: employees at various grade levels, production employees, non-production employees, plant employees, employees at various geographic locations.

9. A computer-implemented method for modifying options and redistributing funds for employee benefits from the prior year total rewards package, wherein the modification and redistribution is based on the prioritization and perceived value of the benefit to a diverse group of employees, the method comprising:
a) defining the total rewards package to include employee benefits as comprising three or more of the following benefits: health care, retirement plan, pension plan, time and attendance benefits, annual employee incentives, long-term incentives, employee pay, financial planning services, wellness incentive program;
b) generating employee input and compiling the results and storing the results using a computer system;
c) analyzing the results to determine the relative value and prioritization of each of the employee benefits in relation to other employee benefits within the total rewards package;
d) creating one or more sample redistributed total rewards packages based on the results of the employee input;
c) applying the sample redistributed total rewards in an advisory group or used on sample employee profiles;
f) measuring the costs and benefits for each employee profile using the sample redistributed total rewards packages; and
g) selecting a final total rewards package from the sample redistributed total rewards packages.
